(19) United States
(12) Patent Application Publication
(10) Pub. No.: US 2003/0097326 A1
(43) Pub. Date: May 22, 2003

(54) Method, system and business model for performing eletronic betting

(76) Inventor: Bjorn Kivimaki, Vantaa (FI)

Correspondence Address: YOUNG & THOMPSON, 745 SOUTH 23RD STREET 2ND FLOOR, ARLINGTON, VA, 22202

(21) Appl. No.: 10/221,790

(22) PCT Filed: Mar. 19, 2001
(86) PCT No.: PCT/FI01/00268

(30) Foreign Application Priority Data
Mar. 17, 2000 (FI) 20000624

(51) Int. Cl. G06F 17/60

(52) U.S. Cl. 705/37

(57) ABSTRACT

The present invention relates generally to a method, a system and a business model for performing electronic betting. The betting may concern e.g. races, matches or casino games. The present invention relates more particularly to implementing online betting with telecommunications media and to measures for making their use easier for an average user. One idea of the present invention is providing a betting system where the betting event is transferred to potential bettors via digital television. The user makes bet orders using return channel messages of the digital television system (214, 230, 234, 250, 255, 260, 270). The betting management system supplies information on the betting objects and betting parameters also on digital television channel(s). This enables to create an entertaining program with online betting. The user of the betting service does not need to have a continuous telephone connection to the service provider. The user may neither need to make specific agreements with the service provider or a bank for the betting payments and rewards in order to use the betting service.

### FIELD OF THE INVENTION

The present invention relates generally to a method, a system and a business model for performing electronic betting. The betting may concern e.g. races, matches or casino games. The present invention relates more particularly to implementing online betting with telecommunications media.

### BACKGROUND OF THE INVENTION

It is well known to arrange betting in e.g. horse races where the audience of the race can make bets prior to a race. However, it may take much time to travel to the races, and it also requires a lot of effort to go to the betting booth, queue up and make a bet. In order to be able to betting at home, also electronic betting services have been developed.

In an Internet-based electronic betting system bets are usually guaranteed by agreements or the bettors may have, for example, a general-purpose account, such as a credit or debit account for paying the bets during the betting. The bettor must therefore have an agreement with a bank and the betting service provider for the payment of bets.

FIG. 1 illustrates a prior art betting management system 100 for receiving and processing bets from one or more bettors 130 and 140. The betting management system 100 processes each received bet to determine whether the bets can be accepted. There is usually one betting service provider that runs the betting management system, but there may also be several service providers 150, 160 in one betting management system. If a betting service provider accepts a given bet, the betting management system 100 binds the bettor to form a legally binding bet contract.

The bets may be guaranteed, for example, using a general purpose account, such as a credit or debit account, maintained by an issuing bank, such as issuing bank 170 and 180. The conditions specified in a bet may also include, for example, a description of the bet. If the bet is successful, a reward is paid to the bettor. For this purpose there is a further contract between the bettor and the betting service provider 150, 160 for binding the service provider to pay the reward to the bettors bank account 170, 180.

As shown in FIG. 1, the CPO management system 100 includes a central controller 190 for processing the information in a manner described above.

Each bettor contacts the betting management system 100, for example, by means of telephone line, in-person contact or through an agent, and provides the betting management system 100 with the terms of their bets. Each bettor may employ a general-purpose computer, for communicating with the betting management system 100. The general-purpose computer of each bettor is usually comprised of a processing unit, a modem, memory means and any software required to communicate with the betting management system 100.

There are certain drawbacks related with the described prior art solutions to implement an electronic betting. The communication between the betting management system and the user is carried out via a telephone line. The user may have a computer with a modem, and the user makes a call to the betting service provider. In order to get information on the betting objects and parameters, and in order to make bets, the user needs to have a continuous telephone connection to the betting management system. A continuous connection thus causes high expenses to the user. It also takes a lot of time for the user to follow the event/betting, and if the communication is made with the user's computer, the user has to stay by the computer for long periods. One possibility could also be to make short connections every now and then, but the drawback with this solution is that the right instant to make a bet may be missed.

Another drawback with the electronic betting services in the Internet is that their use is often not pleasant for all users. Even if the Internet services have gained popularity, many people do not find attractive to communicate with a computer system for long periods.

A further problem is related to authentication of a bettor. Since the user may make binding bets through this telephone connection, there must be an authentication procedure before accepting the user to the electronic betting service. Before this kind of an authentication procedure is possible, there must be an agreement between the user and the electronic betting provider, and the electronic betting provider must give security codes for establishing the connections. A further problem with the prior art solutions is that one needs to have a payment agreement with the betting service provider and a bank as described above. Therefore it may be too troublesome for ordinary potential users to try and start using the betting services.

### SUMMARY OF THE INVENTION

The objective of the present invention is to create a solution for providing betting wherein the above mentioned problems of the prior art solutions are reduced or avoided.

One idea of the present invention is providing an electronic betting system where information on the betting objects is transferred to potential bettors via digital television system. This can be made e.g. in the television program, or by adding text in the program, on so-called teletext (or text TV) pages or on forward interaction channels of the digital television system. The betting management system may comprise a display screen for the audience for showing said information on the betting objects. The information may also broadcasted on digital television. This enables to create an entertaining program, where there is provided real time information for the betting information.

Further, according to the invention, the communication for making bet orders from the user to the betting management system is accomplished by sending digital messages on the return channel of the digital television system using e.g. a user terminal that is connected to a so-called set top box.

The European Telecommunications Standard number ETS 300 800 [1], known also as the DVB-RC (Digital Video Broadcasting-Return Channel) standard and compliant with the DAVIC (Digital Audio-Visual Council) 1.4 standard, lays down the general framework for a implementing digital television. The broadcast of a digital television system consists of transmitting so-called MPEG2-TS packets on an in-band broadcast channel. There is also implemented an uplink transmission channel as a part of bi-directional communication over a cable television network. An apparatus known as the cable modem, or set top box, which is a basically known part of the terminal arrangement located at e.g. a private home, is allowed to emit transmissions in the uplink direction. The transmission can be made, for example, within slots of TDMA frames according to a certain schedule. A centrally located device known as the head-end composes the uplink transmission schedule and communicates the allocated uplink transmission time intervals to the cable modems. The messages that comprise these allocations are known as MAC or Media Access Control messages, and they are complemented by the information of MAC Flags included in the downlink transmission. One of the programming interfaces specified for the digital television is called Multimedia Home Platform MHP, which will probably be the most widely used interface.

The uplink return channel of a digital television system is mainly designed for viewers to take part in different questionnaire and voting, [1]. In such applications it is not necessary or desirable that information on the viewers' identities are collected or analysed. However, since a return channel can be allocated to a dedicated user, the user that is sending a message can be identified. It is also possible to identify the sender of a message from an identification part of a return channel message. This ability to identify the sender of a message can be utilized in the present invention; as it is also essential in providing a betting service, that the betting management system can identify the customer or subscriber sending the message. It is also possible to use the digital television system for confirming the acceptance of an order to the bettor. It is possible to use either a broadcast channel (such as teletext pages) or forward interaction channels for this purpose.

The inventive solution has several advantages over the prior art solutions. The event can be made a very entertaining online program using electronic mass media, and the viewers can have an immediate access to the betting. The user is able to view the event and take part in betting wherever there is the concerned digital TV channel and digital TV terminal available. Therefore a single betting service provider can arrange the betting in the context of a live TV program in any country where the program is visible and where there is a digital TV coverage with return channel communication. A user does not need to make a continuous data connection to the betting management system. The user can also get instant information on a possible acceptance of a user's bet order. And if the user wishes to make a new bet order, the user can send in real time a return channel message with the required bet order information. There is no need to make a new data transfer connection over telephone line involving possible unsuccessful attempts causing a harmful delay in transmitting the order.

A further advantage with the present invention is that the payment of the bet can be confirmed by the digital television system operator. When an order is made with a return channel message, the digital television operator and the betting service provider gets the identification of the subscriber connection where the message has been sent from. This is reliable information on the subscriber and can therefore be used for confirming the bettor. The payment can be added in the subscriber's television subscriber bill or the betting service provider can use the subscriber information for sending an invoice to the bettor. Therefore there is no need for separate payment agreements between a user, the betting service provider and a bank. The only agreement that may be needed is an agreement between the betting service provider and a digital television operator for transaction of the payments. The user can therefore start trying and using the betting service without any additional agreements. This is important for getting the large numbers of television viewers to attend to the betting.

The present invention concerns also a business model for arranging betting in the described manner.

The betting may for example concern results of matches, races or games. As the invention provides a solution for a real time betting, it is can also be used for betting on things that may happen with a very short time interval. For example, betting object may be “who makes the next goal in the hockey match”. And the betting choices may then cover all players or the most probable ones. The evens may be predetermined according to e.g. historical number of goals of each player. Or the evens may be determined by the distribution of bets. Another possible objects for bets may be:

How long does it take to change a tyre in a Formula race for a determined driver?

What is the number of goals in a football match on a certain time instant?

Who gets the next penalty in an ice-hockey match?

The present invention is characterised by the following features:

A method for performing electronic betting on an event, comprising the steps of:

providing several potential bettors with information on a betting object;

obtaining a bet order from a potential bettor;

transferring the information on the bet order from the potential bettor to a betting management system;

providing an acceptance of said bet order;

wherein the step of transferring the information on the bet order from the potential bettor to the system is provided with a digital message on a digital television return channel, and

the potential bettors are provided with said information on the betting object using a channel of a digital television system.

A system for performing electronic betting, comprising:

means for providing at least one potential bettor with information on a product in sale;

means for obtaining a bet order from a potential bettor;

means for receiving the information on the bet order from the potential bettor to a betting management system;

means for providing an acceptance of said bet order;

wherein the means for receiving the information on the bet order from the potential bettor to the system is means for receiving a digital message on a digital television return channel, and

the potential bettors are provided with information on a product in sale using a channel of a digital television system.

A business model for performing betting using telecommunications media, comprising the steps of:

providing several potential bettors with information on a betting object;

obtaining a bet order from a potential bettor;

transferring the information on the bet order from the potential bettor to a betting management system;

providing an acceptance of said bet order;

wherein the step of transferring the information on the bet order from the potential bettor to the system is provided with a digital message on a digital television return channel, and

the potential bettors are provided with information on a betting object using a channel of a digital television system.

Preferred embodiments of the present invention are described in the dependent claims.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating a prior art electronic betting management system;

FIG. 2 is a schematic block diagram illustrating an exemplary electronic betting system according to the invention; and

FIG. 3 illustrates a flow diagram for an exemplary method for providing electronic betting according to the invention until the acceptance of a bet order,

FIG. 4 illustrates a flow diagram for an exemplary method for providing electronic betting according to the invention starting from the acceptance of a bet order,

FIG. 5A illustrates an example of a return message for transmitting a bet order according to the invention, and

FIG. 5B illustrates an example of information content of a message for transmitting a bet order according to the invention.

### DETAILED DESCRIPTION

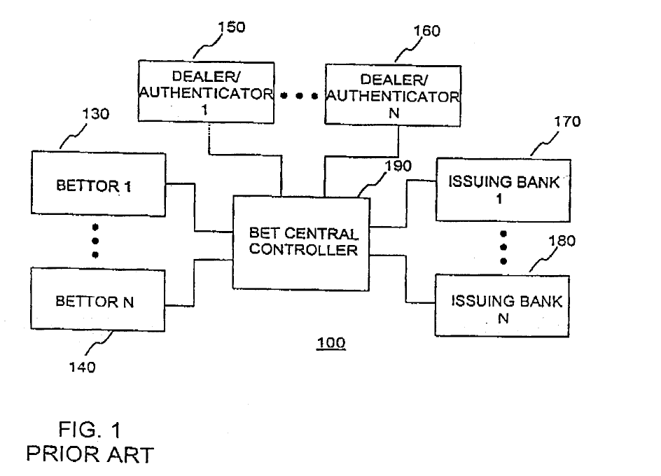

FIG. 1 was described in the prior art section of the specification.

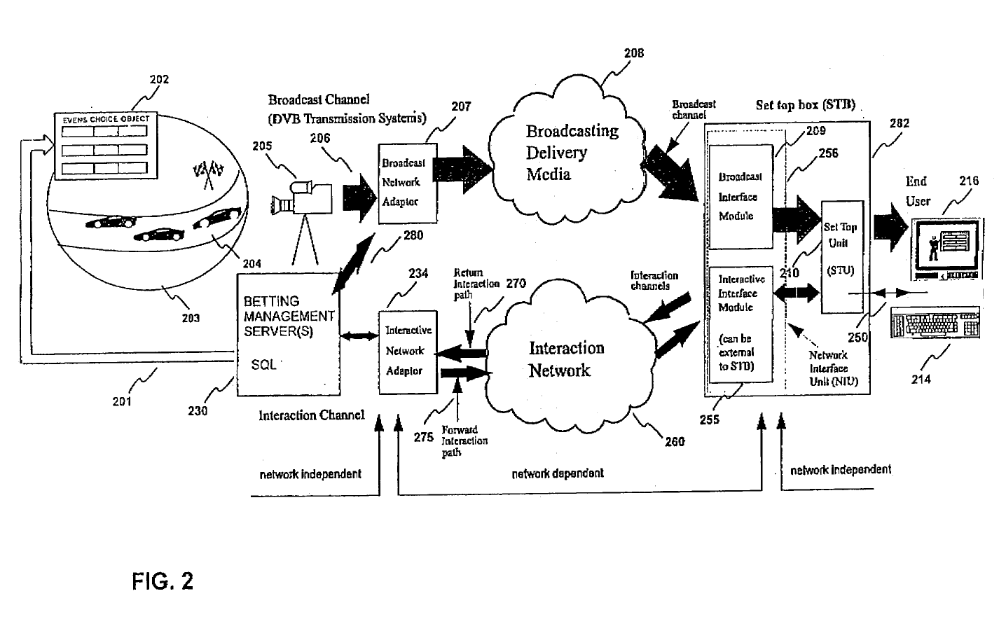

FIG. 2 illustrates an exemplary embodiment of a betting arrangement in accordance with the invention. The event is in this exemplary case a car race. The race is imaged with a TV/video camera 205, and the race is further broadcasted, 206, 207, on digital television broadcast channel 208 as a live program. There may also be audience present in the race. There is, in this case, a large display screen 202 on the race where there may be information on the situation in the race as well as information on possible betting objects and evens. The display screen is controlled by the server of the betting management system 230, and the display can therefore give real time information on the betting. The betting information is also transmitted in digital television, 280, which can be the same television channel where the live event is broadcasted. The betting information can be shown as text, which is added on the video signal to be broadcasted. If the text is added directly to on the broadcasted images, the text is visible for all the viewers of the event. Another possibility is to send the betting information in a teletext service of the broadcast channel. It is then visible for those viewers who have the teletext properties in their television set and who have activated the correct text page in the television set. It is, of course, possible to have teletext information visible together with the program of the event. In order to have real time information on the betting, it is preferable to synchronize the transmission of the betting text pages with the changing incidents of the betting information and/or with incidents of the broadcasted live event.

It is also possible to transmit the betting information as digital messages on a forward interaction channel to the set top boxes of the viewers. A group transmission of messages can be used for this purpose. The messages can be transmitted to those viewers who have informed that they wish to take part in the betting. The bettors can enter on the active list of potential bettors by e.g. sending a return message to the betting service provider. After the bettor does no longer wish to receive the betting information from the concerned event, the bettor can send another return message indicating that the bettor is to be removed from the active list of bettors.

A person who attends to the betting may thus watch the event in the television 216, and receive the betting information e.g. from the TV. In order to view the digital television broadcast, the viewer also needs to have a set top box 282 for interfacing to the broadcast channel, and for achieving authentication for receiving the programmes of the TV operator, 210. If the person wants to make a bet order, the order can be transmitted to the betting management system with a return channel message of the digital television system. A user has a user interface, such as keyboard 214, connected to the set top unit 210 of the set top box 282. The set top unit is further coupled to an interactive interface module 255 of the set top box 282 (it may also be external to the set top box). The interactive interface module interfaces with the interaction network 260 for receiving information from the digital TV system on a forward interaction path/channel 275 and transmitting information on the return interaction path/channel 270. The betting management system is interfaced to the interaction network 260 with an interactive network adaptor 234.

The broadcasting delivery media 208 and the interaction network 260 are described separate in FIG. 2 for clarity, but of course, they may also be implemented using the same media channels.

The system may use e.g. the MHP (Multimedia Home Platform) programming interface. The user interface communication 250 may be realised using e.g. DVB Java and/or DVB HTML languages.

The betting management system 230 may also include interfaces for other kinds of user equipment and communications, such as interfaces for mobile communication systems or the Internet terminals, The betting management system 230 may include, for example, an MS SQL server 7 and an MS IIS 4 Web server (not shown in FIG. 2), just to be mentioned as examples of implementation. The communication between the Internet terminal and the electronic betting management system can be implemented according to the prior art.

A customer that attends to the betting makes a decision on a bet order, connects to the interactive communications of the digital television system and sends the order information to the betting management system with a return channel message.

After the bet order has reached the betting management system, and the bet order has been registered and accepted, the betting management system may send an acknowledgement message to the concerned bettor indicating that the bet has been received and approved (or disapproved). The acknowledgement message can be transmitted with a digital television channel, e.g. the broadcast channel, such as a teletext page (for all viewers), or on forward interaction channel (for the dedicated user(s)).

It is clear that the electronic betting management system may comprise communication ports for many digital television networks that are provided by different operators. These digital television systems may have different communication standards. Most cable digital television systems provide a return channel for sending uplink messages. It is usually not necessary to form a continuous call connection to the operator.

There may also be communication 280 from the DVB transmission system to the betting management server. In many applications it is important that the functions of the betting management server are synchronised with the events of the betting object. For example, a goal in a football game or an ice hockey game may mean that some betting functions must be stopped, and some new betting functions may start. The information on events in the betting object may be received to the betting management server e.g. directly from the broadcast network adaptor by identifying predetermined codes from the DVB information flow. The code may be added automatically by the result management system of the game, or within the camera system 205 by e.g. the person operating it. Also the use of an image recognition procedure is possible for detecting certain events. This way the betting system can be made as automatic as possible.

Another good alternative is that there is a person watching the game (betting object) and after an event sends a predetermined message to the betting management server with e.g. mobile station using a short message (SMS) of a mobile telephone system. The betting management server may also send an acknowledgement message back to the person's mobile station. This way the betting operator can make sure that all events in the game (betting object) are registered and acted on.

The subscriber registers of a digital television system may include information on accumulated value of used services for billing the subscribers. The provider of the electronic betting services may therefore have an agreement with the digital television operator according to which the payments of the purchases are added to the accumulated value of services of the subscriber. Even if the payments are not directed through the digital television system operator, the betting service provider can use the information of the bet order message to authenticate the sender of the message and use it in a direct billing procedure.

The functional units in FIG. 2 are not explained in more detail, as they can be designed by a person skilled in the art using this description of the basic inventive idea. Also functional details as described with FIG. 1 can be applied. One should also note that the “electronic betting management system” may in the simplest form be just a receiver device for receiving digital messages and showing the orders for the personnel of the betting provider. The betting transactions can then be approved manually, if this is desirable.

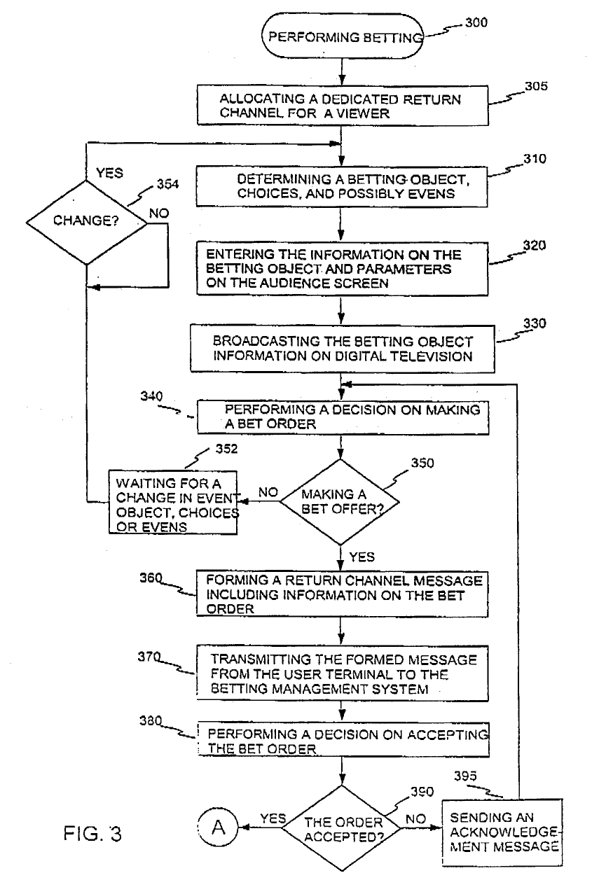

FIG. 3 illustrates a flow diagram of an exemplary method 300 for providing betting according to the invention. First, in order to facilitate bi-directional communication between the viewer and the betting management system, the digital television system may allocate a dedicated return channel for the viewer, step 305. This may be allocated upon request or automatically. If a viewer wants to take part in the betting the viewer may, for example, send an initial message to the betting management system informing chat the user wants to take part in the betting (this step is not shown in the flow diagram). After receiving this initial message, the betting management system enters the subscriber's identity information in said list. It is also possible that no registration of a user is required.

In step 310 the betting service provider determines a betting object and possible choices for betting. The betting service provider may also determine an evens for each choice for betting. The evens means a factor by which the bet stake is multiplied for a reward, if the bet is successful. This is convenient for a bettor, because the bettor knows in advance what the evens is. However, informing a fixed evens means that the betting service provider carries a risk on the betting. Another possibility is to determine the evens according to the amounts of bets for different choices. If the evens is thus calculated, the betting service provider can take a certain percentage of the betting turnover as a profit and does not need to carry a monetary risk for determining the evens parameters.

After the betting object and choices have been determined, the betting management system may enter the information on the betting object, on a display screen for the audience, step 320. This information may include betting objects, choices, evens and bet prices. The betting information is also transmitted to other potential bettors by transmission on a digital television channel, step 330. The information can be included in the mass media program showing the event, or it is possible to use e.g. added text, teletext pages, or forward channels of the digital television system for transmitting the information. If forward channels are used, it is possible to send the information only to a determined group of viewers.

If a viewer wants to take part in the betting the user may, for example, send an initial (return channel) message to the betting management system informing that the user wants to take part in the betting (this step is not shown in the flow diagram). After receiving this initial message, the betting management system enters the subscriber identity information in said list. It is also possible that no registration of a user is required.

When a potential bettor sees information on betting objects, the bettor evaluates whether a bet order should be made, step 340. If the viewer does not find the product information attractive, step 350, the viewer may remain waiting e.g. for changes in the event, in the betting object, in the betting choices or in the evens for the choices, step 352. When the betting situation changes, steps 354, 310, the same steps as described above are repeated.

When the bettor then decides to make a bet order the bettor writes a message according to a determined form that includes information on the bet, step 360. If there is just one choice for betting, it may be unnecessary to identify the choice in the message for the order. The message is then transmitted from the bettor's set top box terminal to the betting management system. The information of the message is then read and stored in the register of the betting management system.

After the bettor has transmitted an order to the betting management system, it may happen that the bet is not accepted, step 390. This may happen for example, because the bet order was received too late or because the predetermined evens has changed and/or does not match with the evens required by the bettor. In such a case an acknowledgement message is transmitted to the bettor informing that the bet was not accepted, step 395. Then the bettor has to make a new evaluation and decision on whether to make a next bet order or not, step 340.

If the bet order matches with the bet object information and parameters of the betting management system, a decision can be made that the bettor's order is accepted. The decision can be made by the betting management system on other predetermined conditions. If all the betting parameters are given by the system, the betting management system may wait for bet orders until a determined time instant, and accept the orders that have been received until the determined time instant. If the bettor can give a desired choice and evens, the system may compare the betting parameters of the bet order and the system, and the decision can be made based on this comparison.

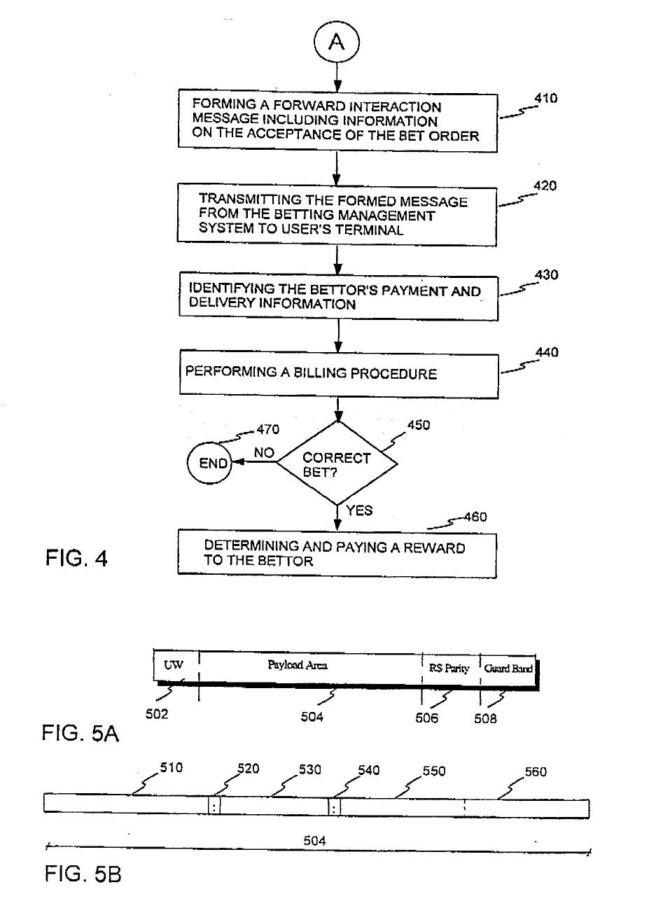

FIG. 4 illustrates a flow diagram on steps after the acceptance of the order in the method of FIG. 3. After the betting management system has accepted the order, the corresponding bettor is informed on the acceptance with an acknowledgement message. One possibility is to give the information on the acceptances of bets via the broadcast channel. However, there may be a need to transmit an acceptance message to the bettor the receipt of which can be confirmed. The message can be transferred by e.g. a message on a forward interaction channel of the digital TV system. In the method of FIG. 4 the betting management system forms a forward interaction message with the information on acceptance of the bet order, step 410. The betting management system then transmits the message to the terminal of the bettor thus indicating that the order has been accepted, step 420.

It is important that there is a way for binding the bettor with the accepted order to pay the bet. The betting service provider may identify the bettor's payment and banking information based on the message that included the accepted order. It is possible to identify the sender of the message on basis of the allocation of the channel on which the message was received. Another possibility is to utilise user information within the message. The betting service provider may get the name and address of the subscriber from the operator of the digital television system or the betting service provider may have its own list of subscriber information.

Another possibility is to use a smart card for authentication of the user. The set top box may have an interface for connecting a smart card, and a smart card may actually be needed for the authentication of the user in order to receive TV programmes. The same smart card could then also be used for authenticating the user of the betting service, so that the changing of a smart card would not be necessary during the watching of television. Alternatively there may be a special smart card issued by the betting service provider needed for the authentication in the betting service. A further possibility is that a general identity smart card, or a banking smart card is used for authentication for using the betting service.

Since the return channel message from the bettor can be reliably authenticated, it is possible to carry out the billing procedure, step 440 the without any separate, complicated authentication of users of the betting service. If the bet of the bettor has been successful, step 450, the betting management system pays a reward for the bettor, step 460. The information on the rewards can be transmitted to bettor(s) via the digital television broadcast channel, such as teletext pages, or on a forward interaction channel. The reward can be paid according to the subscriber information of the bettor via the digital television operator or a mail transfer. It is also possible that the bettor informs a bank account to the betting service provider for the payment of rewards. This can be informed e.g. by sending a (e.g. return channel) message to the betting management system, the message including the bank account number. The betting management system can then identify the sender of the message and interpret the information of the message to mean the bank account for rewards. An advantage in using return channel messages for informing the bettor's bank account is that there is no need to make any special agreements for paying the rewards.

FIG. 5A illustrates an example on a return channel message that can be used for transmitting a bet order to the betting management system according to the invention. The length of the message is e.g. 64 bytes, which is one option available according to the standard [1]. The message includes a user word (UW) 502 for a user check (e.g. 4 bytes), the payload area 504 for the information from the user (e.g. 53 bytes, or characters), a parity check 506 (e.g. 6 bytes), and the guard band 508 (e.g. 1 byte).

FIG. 5B illustrates an example on the user input information for a return channel message that can be used for transmitting an bet order to the betting management system according to the invention. The user area 504 of the message comprises a first identifier field 510 for identifying the object for the bet, such as “F1 winner”. The message further comprises a second identifier field 530 for identifying the choice for the bet, such as “Mika Hakkinen”. This identifier field may not be needed, if there is just one choice available for betting at any time and/or choice that the order is made for. The object and choice may also have a common identifier.

A third identifier field 550 includes the monetary amount that is made for the bet. This identifier field may not be needed, if the bets are made with a fixed price. A third identifier field 570 includes information for authenticating the bettor. This identifier field may not be needed, if the bettor making the order is identified in some other way, such as the subscriber identifier that is transmitted together with the message data. It is also possible to use more than one method for authenticating the user in order to achieve a high degree of security.

The identifier fields are separated with separating characters 520, 540 and 560. In this example the separating character is “:”. The separating character can be any predetermined character or it may consist of more than one successive characters. The message in this example has a maximum length of 160 characters. Usually all this data space is not needed for the order data, so there is unused data space in the message, 560. There may also be other ways to recognize the identifier fields of the message than using separating characters. One alternative possibility is to use predetermined locations for the different identifier fields in the message. However, this solution is more difficult for the user because one would need to check that all the input data is in its correct place in the message.

It is also possible, that the message for making a bet order is formed by the set top box according to simple controls from a user interface unit. The user may, for example, get a suggestion for making an order via the broadcast channel/tv or the interaction network/terminal. It may then be necessary just to press an “enter” key for accepting the order to be made, and the set top box then forms a suitable message for delivering the information on the order to the betting management system.

As mentioned above, the return channel message usually includes, exept the user input data, also information for identifying the subscriber connection where the message is transmitted from.

One should further note that the monetary value of a bet may also be fixed. The advantage of this is also that the user does not need to write bet value information to a message. So it is possible to realise a betting system where it is not necessary to write any information to the message of the bet order.

As described above, the present invention gives remarkable advantages over prior art systems for implementing an electronic betting. When digital television system is used in informing the user about the betting objects, choices and evens, the user gets the information instantly without any need to keep continuous telephone connection to the betting management system.

If return channel messages are used in making bet orders, the user can make a bet quickly without any need to make a telephone connection and authentication procedures. The user does not need to make special agreements with banks or the betting service provider in order to start using the betting service. The user can attend to the betting if the digital TV service and equipment is available. The user does not need to have a phone with Internet connection capabilities, and neither does the digital television system need to have a capability to provide Internet services.

It is to be understood that the embodiments and variations shown and described herein are merely illustrative of the principles of this invention and that various modifications may be implemented by those skilled in the art without departing from the scope and spirit of the invention. Especially, it is to be understood that the present invention is not in any way restricted to the mentioned communications systems or standards. The idea of using return channel messages in making bet orders is not either restricted to the mentioned digital television systems, but it can be applied to any digital television system with the ability to transfer return channel messages. The digital television system includes most preferably a cable television network for the described communications between the user and the digital television operator, but also other communications possibilities can be applied, such as bi-directional wireless links.

The invention is not either restricted for the use in sports or similar events; the invention can as well be applied in e.g. different alive television shows or in playing casino games with a TV for showing the game and making bets. In the specification there is described an advantage of the invention that it is possible to convey the payment of the bet via a digital television operator, but one should understand, that together with the present invention it is also possible to other ways of payment, such as using a separate user register of the betting service provider and user agreements for debiting a registered bettor.

1. A method for performing electronic betting on an event, comprising the steps of:
providing several potential bettors with information on a betting object;
obtaining a bet order from a potential bettor;
transferring the information on the bet order from the potential bettor to a betting management system;
providing an acceptance of said bet order;
wherein the step of transferring the information on the bet order from the potential bettor to the system is provided with a digital message on a digital television return channel, and
the potential bettors are provided with said information on the betting object using first digital transmission on a digital channel of said digital television system, and wherein
said first digital transmission for transmitting said information on the betting object is synchronized with an event in a program, which is transmitted using second digital transmission on a broadcast channel of said digital television system

2. A method according to claim 1, wherein the step of transferring the information on the bet order from the potential bettor to the system comprises the steps of:
forming a message including information on a new order of the potential bettor;
transferring said message from the bettor to the system on a retrun channel of the digital television system; and
reading said information from said message for determining the betting order of said potential bettor.

3. A method according to claim 1, wherein said information on a new bet order of the potential bettor includes at least one of the following information:
betting object,
bet choice,
a betting parameter,
monetary amount of the bet, and
bettor identifier.

4. A method according to claim 3, further comprising the step of initiating a payment of said bet, and the use of said bettor identifier to collect funds from said bettor.

5. A method according to claim 1, further comprising the step of allocating a dedicated return channel for the bettor.

6. A method according to claim 5, further comprising the step of identifying and/or authenticating the potential bettor that has transmitted a message including a bet order on the basis of the allocation of the channel that the message is received from.

7. A method according to claim 1, wherein the information on the betting object comprises at least one of the following information:
the betting object,
betting choices, and
possible monetary amounts of the bets.

8. A method according to claim 1, wherein the channel of a digital television system for providing potential bettors with information on the betting object is a broadcast channel.

9. A method according to claim 8, wherein the information on the betting object is transferred via the teletext service.

10. A method according to claim 1, wherein the event is distributed on a live broadcast on digital television program.

11. A method according to claim 10, wherein the information on the betting object is transmitted on the same media on which the event is distributed.

12. A method according to claim 10, wherein the information on the betting object is transferred via the teletext service using the same television channel as the distribution of the event.

13. A method according to claim 1, wherein information on betting and information on the current evens for a bet are shown on a display screen of the betting management system.

14. A method according to claim 1, wherein said betting object concerns a race, a match or a casino game.

15. A method according to claim 1, wherein the acceptance of the bet order is based on obtaining the bet no later than on a determined point of time.

16. A method according to claim 1, wherein the acceptance of the bet order is based on comparing the evens parameter of the bet order and the evens parameter of the betting management system at the instant of obtaining the bet order.

17. A method according to claim 3, wherein the bet order identifiers of the message are recognised based on at least one separating character between two identifier fields.

18. A method according to claim 1, wherein the payment of the bet is conveyed via a digital television system operator.

19. A method according to claim 1, wherein the bettor is identified on basis of an identifier of a subscriber connection in the digital television system and said identifier is derived based on the received message including information on an order.

20. A method according to claim 1, further comprising a step of transferring an initial message from a bettor's terminal to the betting management system and storing the bettor's identity information on a list of subscribers that take part in the betting.

21. A method according to claim 20, further comprising a step of transferring a termination message from the bettor's terminal to the betting management system and removing the bettor's identity information from the list of subscribers that take part in the betting.

22. A method according to claim 1, wherein the acceptance or non-acceptance of a bet order is informed to the corresponding bettor with a message on a forward interaction channel.

23. A method according to claim 1, wherein the acceptance of a bet order is informed on a broadcast channel, such as teletext page.

24. A method according to claim 1, further comprising the step of identifying and/or authentication the bettor on the basis of a smart card of the bettor.

25. A method according to claim 24, wherein said smart card is also used for identifying and/or authenticating a subscriber interface of the digital television system.

26. A system for performing electronic betting, comprising:
means for providing at least one potential bettor with information on a product in sale;
means for obtaining a bet order from a potential bettor;
means for receiving the information on the bet order from the potential bettor to a betting management system;
means for providing an acceptance of said bet order;
wherein the means for receiving the information on the bet order from the potential bettor to the system is means for receiving a digital message on a digital television return channel, and
means for providing the potential bettors with said information on the betting object are arranged to apply first digital transmission on a digital channel of said digital television system, and wherein
the system further comprises means for synchronizing said first digital transmission for transmitting said information on the betting object with an event in a program, which is transmitted by means using second digital transmission on a broadcast channel of said digital television system.

27. A system according to claim 26, wherein the means for receiving the information on the bet order from the potential bettor to the system further comprises:
means for receiving a message from the potential bettor to the system; and
means for reading information on a new bet order of the potential bettor from said message.

28. A system according to claim 26, wherein said information on a new bet order of the potential bettor includes at least one of the following information:
betting object,
bet choice,
a betting parameter,
monetary amount of the bet, and
bettor identifier.

29. A system according to claim 28, further comprising means for initiating a payment of said bet, and the use of said bettor identifier to collect funds from said bettor.

30. A system according to claim 26, further comprising means for allocating a dedicated return channel for a terminal of the potential bettor.

31. A system according to claim 30, further comprising means for identifying the potential bettor that has transmitted a message including a bet order on the basis of the allocation of the channel that the message is received from.

32. A system according to claim 26, wherein the information on the betting object comprises at least one of the following information:
the betting object,
betting choices, and
possible monetary amounts of the bets.

33. A system according to claim 26, wherein the channel of a digital television system for providing potential bettors with information on a product in sale is a broadcast channel.

34. A system according to claim 26, comprising a display screen for showing information on the betting objects for the audience of the event.

35. A system according to claim 26, wherein said betting object concerns a race, match or a casino game.

36. A system according to claim 26, comprising means for the acceptance of the bet order based on obtaining the bet latest on a determined point of time.

37. A system according to claim 26, comprising means for the acceptance of the bet order based on comparing the evens parameter of the bet order and the evens parameter of the betting management system at the instant of obtaining the bet order.

38. A system according to claim 27, comprising means for recognising the bet order identifiers of the message based on at least one separating character between two identifier fields.

39. A system according to claim 26, comprising means for conveying the payment of the bet via the digital television system operator.

40. A system according to claim 26, comprising means for identifying and/or authenticating the bettor on basis of an identifier of a subscriber connection in the digital television system.

41. A system according to claim 26, comprising means for identifying and/or authenticating the bettor on the basis of a smart card that is connected to a bettor's terminal.

42. A system according to claim 26, comprising means for identifying and/or authenticating both the bettor and a subscriber interface on the basis of a same smart card that is connected to a bettor's terminal.

43. A system according to claim 26, further comprising means for transferring an initial message from a bettor's terminal to the betting management system and means for storing the bettor's identity information on a list of subscribers that take part in the betting.

44. A system according to claim 43, further comprising means for transferring a termination message from a bettor's terminal to the betting management system and means for removing the bettor's identity information from the list of subscribers that take part in the betting.

45. A system according to claim 26, comprising means informing on the acceptance of a bet order to the corresponding bettor with a message transferred on a forward interaction channel.

46. A system according to claim 26, comprising means for informing the acceptance of a bet order on a broadcast channel of the digital television system, such as teletext page.

47. A business model for performing betting using telecommunications media, comprising the steps of:
providing several potential bettors with information on a betting object;
obtaining a bet order from a potential bettor;
transferring the information on the bet order from the potential bettor to a betting management system;
providing an acceptance of said bet order;
wherein the step of transferring the information on the bet order from the potential bettor to the system is provided with a digital message on a digital television return channel, and
the potential bettors are provided with said information on the betting object using first digital transmission on a digital channel of said digital television system, and wherein
said first digital transmission for transmitting said information on the betting object is synchronized with an event in a program, which is transmitted using second digital transmission on a broadcast channel of said digital television system.

48. A business model according to claim 47, wherein the potential bettors are provided with information on the betting objects using a broadcast channel of the digital television system.

49. A business model according to claim 47, wherein the potential bettors are provided with information on the betting objects using a forward interaction channel of the digital television system.

50. A business model according to claim 47, wherein the betting object concerns an event with an audience, and the information on the betting object is displayed on a display screen which is visible for the audience of the event.
